(19) United States
(12) Patent Application Publication
(10) Pub. No.: US 2010/0049926 A1
(43) Pub. Date: Feb. 25, 2010

(54) ENHANCEMENT OF DATA MIRRORING TO PROVIDE PARALLEL PROCESSING OF OVERLAPPING WRITES

(75) Inventors: Carlos F. Fuente, Southampton (GB); William J. Scales, Fareham (GB); John P. Wilkinson, Romsey (GB)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/195,707

(22) Filed: Aug. 21, 2008

(51) Int. Cl. G06F 12/16

(52) U.S. Cl. 711/162; 711/E12.103

(57) ABSTRACT

A storage unit adapted for use in a processing system, includes: a journal for managing execution of incomplete writing of data for at least two segments of data, wherein a designated storage location for the first write of data overlaps a least a portion of a designated storage location for the second write of data, wherein the journal includes a reference table for tracking incomplete writes of data; and, the journal includes machine executable instructions stored within machine readable media for performing the managing by: monitoring writes of data to identify incomplete writes of data sharing at least one designated storage location of a primary media; reading the associated writes of data into the reference table; sequencing the associated writes of data in the reference table; and writing the data in the reference table in sequence order to each designated storage location of the primary media and associated secondary media.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This invention relates to redundant data storage, and particularly to parallel processing of overlapping writes in a computing infrastructure.

2. Description of the Related Art

It is common for data systems of today to use redundant storage. This provides users with high integrity data and great system reliability. However, designs for redundant storage systems are often complicated. Increased demands for performance continue to call for advancements in the design.

One design allows many writes to be handled in parallel across a remote copy relationship, applying them in order at the secondary location to maintain application power-fail consistency but providing negligible slowdown at the primary location. The combined design is able to maintain consistency even in the face of disruptions to the transmission operations, such as node failures or transient communication failures. But this ability is limited by using the primary copy of a disk as the known good copy of data, should retransmission be necessary. This results in a limitation to a single outstanding write for any given location on a secondary disk. This problem is known as a “colliding write” or “overlapping write” limitation. Any write which overlaps an earlier write must wait for the earlier write to be committed at the secondary location, and that result to be communicated to the primary site. As a result, the system committing the overlapping write will be forced to wait for the full round-trip delay of the primary write. This can, of course, result in degraded performance when compared with non-overlapping writes.

What are needed are techniques for improving performance of secondary writing in data storage systems. Preferably, the techniques mitigate or eliminate overlapping write limitations.

### BRIEF SUMMARY

The shortcomings of the prior art are overcome and additional advantages are provided through the provision of a storage unit adapted for use in a processing system, the storage unit including: a journal for managing execution of incomplete writing of data for at least two segments of data, wherein a designated storage location for the first write of data overlaps a least a portion of a designated storage location for the second write of data, wherein the journal includes a reference table for tracking incomplete writes of data; and, the journal includes machine executable instructions stored within machine readable media for performing the managing by: monitoring writes of data to identify incomplete writes of data sharing at least one designated storage location of a primary media; reading the associated writes of data into the reference table; sequencing the associated writes of data in the reference table; and writing the data in the reference table in sequence order to each designated storage location of the primary media and associated secondary media.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which software is used to provide a storage system with capabilities for rapid storage of overlapping data, particularly in systems implementing redundant arrays of storage devices.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a processing system that makes use of a storage system as disclosed herein;

FIG. 2 illustrates aspects of a primary storage unit (e.g., a hard disk); and

FIG. 3 illustrates writes of overlapping data in relation to a primary media.

The detailed description explains the preferred embodiments of the invention, together with advantages and features, by way of example with reference to the drawings.

### DETAILED DESCRIPTION

Disclosed herein are methods and apparatus for minimizing performance degradation with colliding writes to secondary storage. The solution provided includes a data journal for tracking overlapped writes. In general, data from a host for ongoing or incomplete writing of data (which may be referred to as “in-flight writes”) and subject to being overlapped is read into the journal before it is overwritten on the primary disk. Information from the journal and data maintained by the journal may be used for recovery.

Once the journal is established in non-volatile memory of the primary system, then an overlapping host write is released and can be applied to the primary storage and then completed to the host, even while the overlapped write is still in flight to the secondary site. As a result, the host application at the primary site will experience an improved response time. Care is taken in recovery to ensure that the overlapping writes do not create an inconsistent state. Having provided this introduction, consider now aspects of a processing system for practicing the teachings herein.

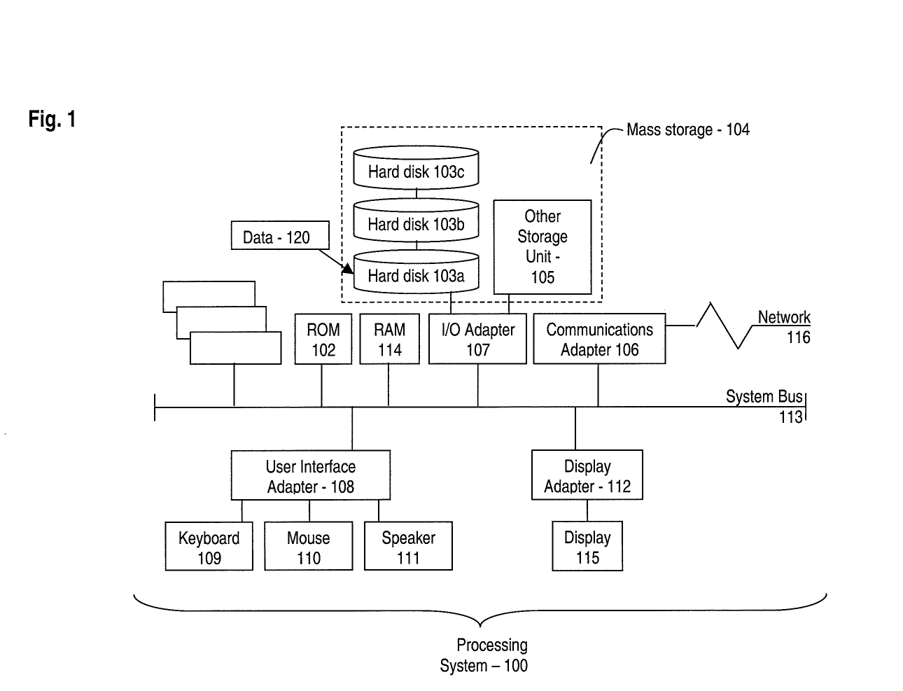

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a mass storage unit 104. The mass storage unit 104 may include, for example, a plurality of hard disks 103a, 103b,103c, etc, . . . and/or another storage unit 105 such as a tape drive, an optical disk, and a magneto-optical disk or any other similar component. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 106 for communicating over a network 116. The network 116 can be a local-area network (LAN), a metro-area network (MAN), or wide-area network (WAN), such as the Internet or World Wide Web, or any other type of network 116.

Users of the system 100 can connect to the network 116 through any suitable network interface 106 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

Of course, the processing system 100 may include fewer or more components as are or may be known in the art or later devised.

As disclosed herein, the processing system 100 includes machine readable instructions stored on machine readable media (for example, the hard disk 103). As discussed herein, the instructions are referred to as “software”. Software as well as data and other forms of information may be stored in the mass storage 104 as data 120.

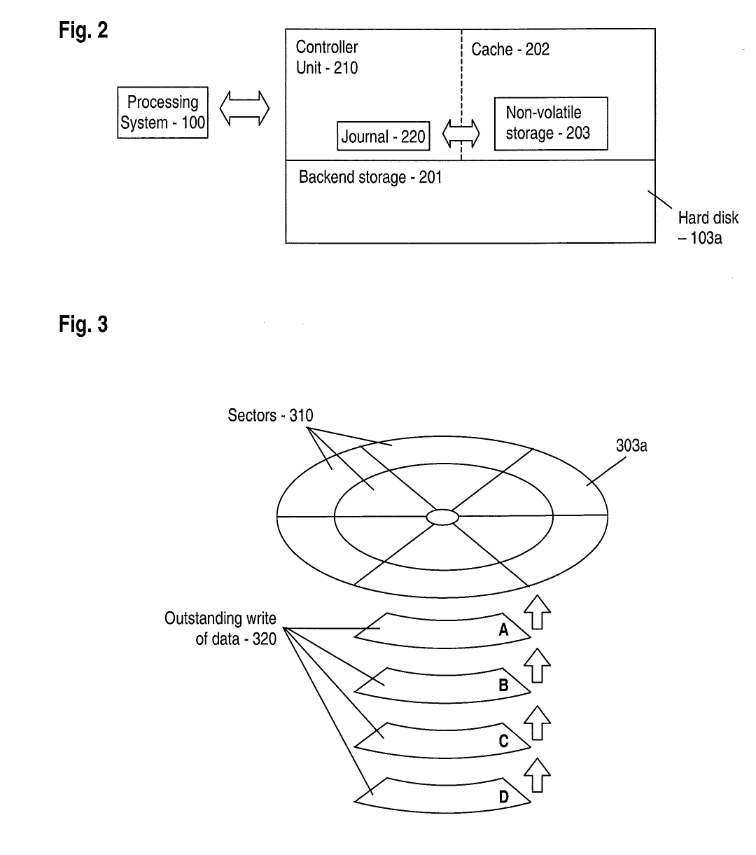

With reference to FIG. 2, the mass storage 104, or simply “storage” 104, may include any type of a variety of devices used for storing software 120, data and the like. In the example provided in FIG. 1, the storage 104 includes a plurality of hard disks 103a, 103b, 103c, . . . In this example, a first hard disk 103a is considered a primary hard disk, and used for initial writing. Secondary hard disks 103b, 103c may fulfill a variety of uses, including mirroring (i.e., duplication of) the primary hard disk 103a. Although each hard disc 103 may serve a specified purpose, in some embodiments, the actual structure of each hard disk 103 is identical to the structure of the other hard disks 103.

Generally, each device (such as the hard disk 103) provided as a component of the storage 104 includes a controller unit 210, a cache 202, and a backend storage 201. Non-volatile storage 203 (i.e., memory) may be included as an aspect of the controller unit 210, or otherwise included within the storage 104. The backend storage 201 generally includes machine readable media for storing at least one of software 120, data and other information as electronic information.

As is known in the art, the controller unit 210 generally includes instructions for controlling operation of the storage 104. The instructions may be included in firmware (such as within read-only-memory (ROM)) on board the controller unit 210, as an built-in-operating-system for the storage 104 (such as software that loads to memory of the controller unit 210 when powered on), or by other techniques known in the art for including instructions for controlling the storage unit 104.

In the example of FIG. 2, the primary hard disk 103a is shown. Included is a journal 220, which tracks “in-flight writes” of data. That is, the journal 220 provides a reference for tracking ongoing writing of data to secondary hard disks 103b, 103c, . . . The journal 220 may include a reference table, a data table, machine executable instructions for implementing a method for management of in-flight writes, and other such components. A sequence of multiple writes is better shown by FIG. 3.

In FIG. 3, a plurality of outstanding writes of overlapping data 320 are shown. In this example, each outstanding write of overlapping data 320 is in line for writing to a disk sector 310 of primary media 303a (i.e., media in the primary disk 103a).

When two writes are outstanding for a given location, the earlier write is referred to as an “overlapped” write, and the latter as the “overlapping” write. When more than two are writes are outstanding, each adjacent pair of the outstanding writes of overlapping data 320 have an overlapped and overlapping pair. For instance, with four outstanding writes of overlapping data 320 to the same location, A, B, C, and D, are dispatched in that order. In this example, D is the overlapping write for C, C is the overlapped write for D and the overlapping write for B, and so on. A write may also overlap multiple non-overlapping writes, for instance a write to disk sectors 0-9 may overlap a write to disk sectors 0-4 and another to disk sectors 5-9. Equivalently, a write may be overlapped by multiple mutually overlapping and non-overlapping writes.

When the primary hard disk 103a receives an overlapping write (the write shares common locations with at least one outstanding write), the journal 220 does not permit the write of overlapping data 320 to proceed. Instead, the journal 220 triggers reading of the overlapped write or writes into a separate non-volatile storage 203. Detection of the outstanding writes of overlapping data 320 may be performed with a lock mechanism such as one used to prevent multiple overlapped writes being accepted from the host in parallel. Only when reads for all the overlapped writes 320 have completed is the overlapping write 320 allowed to proceed. The reads provide minimal slowdown, as the data will have just been written and so will be cached.

With both the overlapped and overlapping writes in flight, correct ordering is guaranteed by the sequence numbers attached to each of the writes. Re-reading into the buffer ensures that the overlapping and overlapped writes 320 do not share sequence numbers. With this guarantee, the existing design can cope with the transmission of multiple mutually overlapping writes, and writing them on the secondary system whilst maintaining data consistency.

In one embodiment, if there is a communication error, the journal 220 provides a protocol that disconnects, reconnects, and retransmits any writes that it has not had write completion of from the secondary system (i.e., secondary hard disks 103b, 103c, . . . ). For normal writes, the journal 220 will re-read data from the primary disk 103a for retransmission. For writes that have been overlapped, the journal 220 must use the data previously stored in the buffer of non-volatile storage 203.

The capabilities of the present invention can be implemented in software, firmware, hardware or some combination thereof As an example, the controller unit 210 may implement the journal 220 as machine executable instructions loaded from at least one of backend storage 201, non-volatile storage 203, local read-only-memory (ROM) and other such locations. The journal 220 may be implemented in other locations, such as on board the processing system 100.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A storage unit adapted for use in a processing system, the storage unit comprising:
a journal for managing execution of incomplete writing of data for at least two segments of data, wherein a designated storage location for the first write of data overlaps a least a portion of a designated storage location for the second write of data, wherein the journal comprises a reference table for tracking incomplete writes of data; and,
the journal comprises machine executable instructions stored within machine readable media for performing the managing by:
monitoring writes of data to identify incomplete writes of data sharing at least one designated storage location of a primary media;
reading the associated writes of data into the reference table;
sequencing the associated writes of data in the reference table; and
writing the data in the reference table in sequence order to each designated storage location of the primary media and associated secondary media.
